(19) United States
(12) Patent Application Publication
(10) Pub. No.: US 2013/0127444 A1
(43) Pub. Date: May 23, 2013

(54) APPARATUS AND METHOD FOR DISTINGUISHING BETWEEN TACK-WELDING AND WELDING

(71) Applicants: Eui Koog Ahn, Incheon (KR); Lock-Jo Koo, Gyeonggi-do (KR); hee won Jo, Chungcheongbuk-do (KR); Seung Taek Hong, Gyeonggi-do (KR); Chang Ho Lee, Gyeonggi-do (KR); Gi Nam Wang, Gyeonggi-do (KR); Sang Chul Park, Gyeonggi-do (KR)

(72) Inventors: Eui Koog Ahn, Incheon (KR); Lock-Jo Koo, Gyeonggi-do (KR); hee won Jo, Chungcheongbuk-do (KR); Seung Taek Hong, Gyeonggi-do (KR); Chang Ho Lee, Gyeonggi-do (KR); Gi Nam Wang, Gyeonggi-do (KR); Sang Chul Park, Gyeonggi-do (KR)

(73) Assignee: UDMTEK CO., LTD., Gyeonggi-do (KR)

(21) Appl. No.: 13/812,550

(22) PCT Filed: Jul. 27, 2011
(86) PCT No.: PCT/KR2011/005517

§ 371 Date: Jan. 28, 2013

(30) Foreign Application Priority Data
Jul. 28, 2010 (KR) KR10-2010-0072816

(51) Int. Cl. B23K 9/095

(52) U.S. Cl. CPC B23K 9/0956
USPC 324/113

(57) ABSTRACT

An apparatus and method for distinguishing between tack-welding and welding are provided. The apparatus for distinguishing between tack-welding and welding includes: a current sensor configured to detect arc current of a welder; and a distinguish control unit configured to distinguish whether a welding operation performed by the welder is tack-welding or welding based on the arc current detected by the current sensor for a predefined period of time. Accordingly, the amount of work performed by a welding worker can be fairly and accurately evaluated.

### TECHNICAL FIELD

The following description relates to a welding system, and more particularly, to a technique for automatically distinguishing whether a welding operation performed by a welder is tack-welding or welding by detecting arc current of the welder.

### BACKGROUND ART

In construction fields requiring welding operations, for example, in shipbuilding and the like, evaluation of job performance of welding workers is generally based on welding workers' own inputting of the amount of work done or based on field manager's estimation on the amount of work done by each welding worker.

However, it is inconvenient for the welding workers to manually calculate and input the amount of work done for each welding operation, and thus the welding workers may not input the work result properly. Hence, there may be a problem in that the work result data obtained from the welding workers is not reliable.

In contrast, the estimation by the field manager can obtain more reliable work result data than the welding workers' own recording whereas it takes a substantial amount of time to inspect job progress. This may result in reducing a time for improving working environment or increasing productivity.

Accordingly, the evaluation of the amount of work done by welding workers needs to be automated in an effort to ensure the reliability of workload data, improve working environment, and increase the productivity. For automated evaluation of the amount of work by each welding worker, primarily it is required to automatically distinguish whether a welding operation performed by a welder is tack-welding (temporary-welding) or welding.

### DISCLOSURE OF INVENTION

### Technical Problem

Provided is an apparatus and method for automatically distinguishing whether a welding operation performed by a welder is tack-welding or welding by detecting arc current of the welder.

### Solution to Problem

In one general aspect, there is provided an apparatus for distinguishing between tack-welding and welding, including: a current sensor configured to detect arc current of a welder; and a distinguish control unit configured to distinguish whether a welding operation performed by the welder is tack-welding or welding based on the arc current detected by the current sensor for a predefined period of time.

The apparatus may further include a storage unit configured to store information regarding an amount of tack-weld electronic charges and information regarding an amount of weld electronic charges for distinguishing whether a welding operation performed by the welder is tack-welding or welding.

The distinguish control unit may be further configured to obtain an amount of electronic charges consumed by the welder based on the current detected by the current sensor for the predefined period of time, and compare the obtained amount of consumed electronic charges with the information regarding an amount of tack-weld electronic charges and the information regarding an amount of weld electronic charges to distinguish whether the welding operation performed by the welder is tack-welding or welding.

There is another general aspect, there is provided a method of distinguishing between tack-welding and welding, including: detecting arc current of a welder; and distinguishing whether a welding operation performed by the welder is tack-welding or welding based on the arc current detected for a predefined period of time.

The distinguishing of whether the welding operation performed by the welder is tack-welding or welding may include obtaining an amount of electronic charges consumed by the welder based on the current detected for the predefined period of time, and comparing the obtained amount of consumed electronic charges with the information regarding an amount of tack-weld electronic charges and the information regarding an amount of weld electronic charges to distinguish whether the welding operation performed by the welder is tack-welding or welding.

### Advantageous Effects of Invention

According to an apparatus and method for distinguishing between tack-welding and welding, arc current of a welder is detected and it is automatically distinguished whether a welding operation performed by the welder is tack-welding or welding based on the detected current, and consequently the amount of work done by a welding worker can be fairly and accurately evaluated.

### BRIEF DESCRIPTION OF DRAWINGS

FIG. 1 is an illustration of an apparatus for distinguishing between tack-welding and welding according to an exemplary embodiment of the present invention.

FIG. 2 is a flowchart depicting a method for an apparatus for distinguishing between tack-welding and welding according to an exemplary embodiment of the present invention.

### BEST MODE FOR CARRYING OUT THE INVENTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

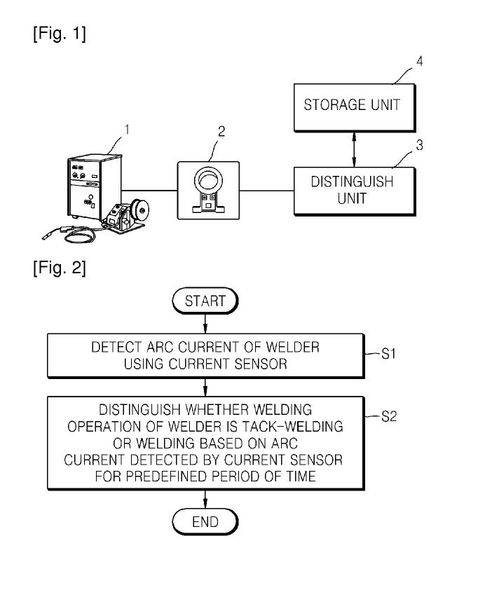

FIG. 1 shows an illustration of an apparatus for distinguishing between tack-welding and welding according to an exemplary embodiment of the present invention. As shown in the example illustrated in FIG. 1, the apparatus may include a welder 1, a current sensor 2, and a distinguish control unit 3.

The current sensor 2 may detect arc current that is consumed by the welder 1.

The distinguish control unit 3 may distinguish whether a welding operation performed by the welder 1 is tack-welding or welding based on the arc current detected by the current sensor 2. The tack welding is a necessary preliminary procedure in many welding projects and is temporary means to hold basic components in the proper location until welding is completed, while controlling and contrasting the movement and distortion of the components during welding and ensuring the precise alignment between the components.

Furthermore, the apparatus shown in the example illustrated in FIG. 1 may further include a storage unit 4.

The storage unit 4 may store information regarding the amount of tack-weld electronic charges and information regarding the amount of weld electronic charges for distinguishing whether a welding operation performed by the welder 1 is tack-welding or welding. Each of information regarding the amount of the tack-weld electronic charges and the amount of the weld electronic charges that are stored in the storage unit 4 may be obtained by dividing arc current consumed by the welder 1 for a predefined period of time during each welding operation by the number of arcs occurring.

The pieces of information regarding the amount of the tack-weld electronic charges and the amount of the weld electronic charges are used to distinguish a welding operation performed by the welder 1 is tack-welding or welding.

The distinguish control unit 3 may obtain the amount of electronic charges consumed by the welder 1 based on the currents detected by the current sensor 2 for the predefined period of time, and compare the obtained amount of electronic charges with the information regarding the amount of tack-weld electronic charges and information regarding the amount of weld electronic charges, thereby distinguishing whether a welding operation performed by the welder 1 is tack-welding or welding.

In other words, the distinguish control unit 3 may obtain the amount of electronic charges consumed by the welder 1 by multiplying the detected current value by predefined time. Then, the distinguish unit 3 may compare the amount of electronic charges consumed for the predefined period of time with the information regarding the amount of tack-weld electronic charges and information regarding the amount of weld electronic charges, each of which is stored in the storage unit 4, in an effort to distinguish whether the welding operation performed by the welder 1 is tack-welding or welding.

As such, the apparatus according to the exemplary embodiment uses the current sensor 2 to detect arc current consumed by the welder 1 for a predefined period of time, obtains the amount of electronic charges consumed for a predefined period of time using the detected arc current value and predefined time information, and compares the obtained amount of the consumed electronic charges with the information regarding the amount of tack-weld electronic charges and information regarding the amount of weld electronic charges so as to distinguish whether the welding operation performed by the welder 1 is tack-welding or welding. Accordingly, the amount of work performed by a welding worker can be fairly and accurately evaluated.

FIG. 2 illustrates a flowchart depicting a method for an apparatus for distinguishing between tack-welding and welding according to an exemplary embodiment of the present invention.

Referring to FIG. 2, an apparatus for distinguishing between tack-welding and welding detects arc current of a welder using a current sensor (S1). Thereafter, the apparatus uses the arc current detected for a predefined period of time to distinguish whether a welding operation performed by the welder is tack-welding or welding (S2).

At this time, to distinguish between tack-welding and welding, the apparatus obtains the amount of electronic charges consumed by the welder based on the current detected by the current sensor for the predefined period of time. Thereafter, the apparatus compares the obtained amount of consumed electronic charges with previously set information regarding the amount of tack-weld electronic charges and information regarding the amount of weld electronic charges in an effort to distinguish whether the welding operation performed by the welder is tack-welding or welding.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### INDUSTRIAL APPLICABILITY

This invention can be used in the field of welding operation.

What is claimed is:

1. An apparatus for distinguishing between tack-welding and welding, comprising:
a current sensor configured to detect arc current of a welder;
a distinguish control unit configured to distinguish whether a welding operation performed by the welder is tack-welding or welding based on the arc current detected by the current sensor for a predefined period of time; and
a storage unit configured to store information regarding an amount of tack-weld electronic charges and information regarding an amount of final-weld electronic charges for distinguishing whether a welding operation performed by the welder is tack-welding or final-welding,
wherein the distinguish control unit is further configured to obtain an amount of electronic charges consumed by the welder based on the current detected by the current sensor for the predefined period of time, and compare the obtained amount of consumed electronic charges with the information regarding an amount of tack-weld electronic charges and the information regarding an amount of final-weld electronic charges to distinguish whether the welding operation performed by the welder is tack-welding or final welding.

2-3. (canceled)

4. A method of distinguishing between tack-welding and welding, comprising:
detecting arc current of a welder; and
distinguishing whether a welding operation performed by the welder is tack-welding or welding based on the arc current detected for a predefined period of time,
wherein the distinguishing of whether the welding operation performed by the welder is tack-welding or final welding comprises:
obtaining an amount of electronic charges consumed by the welder based on the current detected for the predefined period of time, and
comparing the obtained amount of consumed electronic charges with the information regarding an amount of tack-weld electronic charges and the information regarding an amount of final-weld electronic charges to distinguish whether the welding operation performed by the welder is tack-welding or final welding.

5. (canceled)
